(19) United States
(12) Patent Application Publication
(10) Pub. No.: US 2021/0347514 A1
(43) Pub. Date: Nov. 11, 2021

(54) INTEGRATED CAP ROTATION EQUIPMENT

(71) Applicants: HSAO-SZU CHANG, Miaoli County (TW); Marketech International Corp., Taipei City (TW)

(72) Inventors: Ping-Hsu CHEN, Taichung City (TW); Chien-Kuo LU, Hsinchu City (TW); Hsao-Szu CHANG, Miaoli County (TW)

(21) Appl. No.: 17/070,907

(22) Filed: Oct. 14, 2020

(30) Foreign Application Priority Data
May 6, 2020 (TW) 109115104

(51) Int. Cl. B65B 69/00

(52) U.S. Cl. CPC B65B 69/0075

(57) ABSTRACT

An integrated cap rotation equipment includes a cap rotation module supporter and a cap rotation module. The cap rotation module includes a cap rotation device, an integrated connecting device and an optical detector. The cap rotation device is used to open a sealing cap of at least one chemical storage container, and the integrated connecting device is used to connect an opening of the chemical storage container to extract a chemical liquid from the chemical storage container and return the chemical liquid to the chemical storage container. The optical detector is disposed between the cap rotation device and the integrated connecting device, and is used to detect the position of the sealing cap of the chemical storage container, so that the cap rotation device and the integrated connecting device are able to align with the sealing cap and the opening, respectively.

### RELATED APPLICATIONS

This application claims priority to Taiwan Application Serial Number 109115104, filed May 6, 2020, which is herein incorporated by reference.

### TECHNICAL FIELD

The present disclosure generally relates to a cap rotation equipment. More particularly, the present disclosure relates to an integrated cap rotation equipment.

### BACKGROUND

With the booming of the domestic and international semiconductor markets in recent years, due to the demand for computers and the peripheral products thereof, the semiconductor industry has continued to expand, and created a large amount of foreign exchange earnings.

The manufacturing processes of semiconductor components are very complicated, and the technologies involved cover almost all of the most important and critical technologies and inventions of modern scientific research. Therefore, the semiconductor industry is not only a cutting-edge technology industry, but also requires a lot of money to maintain high-end research.

Due to the increasingly complicated design of semiconductor components, the manufacturing technologies of semiconductor components are becoming more sophisticated and complex, and the potential occupational hazards and property losses are becoming more serious in semiconductor processes. Chemicals are commonly used in processes such as epitaxy, diffusion, ions implantation, chemical vapor deposition, etching and lithography. The storage and usage in the semiconductor fabrication plant is much less than the storage and usage in a chemical or petrochemical plant. However, since the chemicals are flammable, toxic and corrosive, the chemical substances may cause personal injury and serious property damage if leakage or abnormal operation occurs.

In a semiconductor fabrication plant, chemical liquids are stored in chemical storage drums to connect to a supply line in the semiconductor fabrication plant. When the chemical liquid is used up, the chemical storage container need to be replaced.

How to easily replace the chemical storage container may improve the safety of the semiconductor fabrication plant, and further improve the yield thereof.

### SUMMARY

One objective of the embodiments of the present invention is to provide an integrated cap rotation equipment able to conveniently replace the chemical storage container, thereby improving the safety and convenience of replacing the chemical storage container.

To achieve these and other advantages and in accordance with the objective of the embodiments of the present invention, as the embodiment broadly describes herein, the embodiments of the present invention provides an integrated cap rotation equipment including a cap rotation module supporter and at least one cap rotation module coupling to the cap rotation module supporter. The cap rotation module includes a cap rotation device, an integrated connecting device and an optical detecting device. The cap rotation device opens a sealing cap of a chemical storage container, the integrated connecting device is then coupled to the opening of the chemical storage container to extract a chemical liquid from the chemical storage container and allow the chemical liquid returning to the chemical storage container. The optical detecting device is disposed between the cap rotation device and the integrated connecting device, and the optical detecting device detects a position of the sealing cap of the chemical storage container to allow the cap rotation device able to align with the sealing cap and then the integrated connecting device is able to align with the opening to utilize the cap rotation device opening the sealing cap and then the integrated connecting device extracting the chemical liquid.

In some embodiments, the integrated connecting device includes an integrated connecting head, a liquid extracting pipe connecting to the integrated connecting head, a liquid return pipe connecting to the integrated connecting head and an air input pipe connecting to the integrated connecting head.

In some embodiments, the liquid extracting pipe, the liquid return pipe and the air input pipe respectively include a check valve.

In some embodiments, the cap rotation module supporter includes a horizontal moving module to move the cap rotation module between a plurality of chemical storage containers and align with one of the chemical storage containers.

In some embodiments, a number of the at least one cap rotation module is plural, and the cap rotation modules respectively correspond to one corresponding chemical storage container of the chemical storage containers to extract chemical liquids in the chemical storage containers.

In some embodiments, the cap rotation module supporter includes a horizontal moving module to move the cap rotation module aligning with the chemical storage container, and the chemical storage container is an intermediate bulk container (IBC).

In some embodiments, the integrated cap rotation equipment further includes a chemical storage container storing device, and the chemical storage container storing device includes a supporting frame to store the intermediate bulk container and the cap rotation module supporter is disposed on the supporting frame.

In some embodiments, the cap rotation device includes a cap rotator, the optical detecting device detects the position of the sealing cap of the chemical storage container to allow the cap rotator aligning with the sealing cap and opening the sealing cap.

In some embodiments, the integrated cap rotation equipment further includes a fixing plate, a vertical moving device connecting between the fixing plate and the cap rotation device or between the fixing plate and the integrated connecting device to move the cap rotation device or the integrated connecting device, and a horizontal moving device connecting between the fixing plate and a base plate to horizontal moving the cap rotation device or the integrated connecting device.

In some embodiments, the integrated cap rotation equipment further includes an isolating plate and an elastic isolating shield connecting to the isolating plate and the base plate to isolate a volatilized chemical gas of the chemical storage container.

Hence, the integrated cap rotation equipment can be safely and reliably configured above the existing chemical storage container, and utilizes a cap rotation device and an integrated connecting device to extract the chemical liquid in the chemical storage container. A single integrated connecting device can extract and reflux the chemical liquid and provide the required gas at the same time. In addition, the integrated cap rotation equipment can also be installed in the exclusive chemical storage container storing device, so as to use the chemical liquid in the chemical drum without departing from the spirit and the scope of the invention. Furthermore, the integrated cap rotation equipment can also utilize a single cap rotation module to extract and reflux the chemical liquid from multiple chemical drums, or multiple cap rotation modules to extract and reflux the chemical liquid from multiple chemical drums at the same time, which does not depart from the spirit and scope of the present invention. In addition, the integrated cap rotation equipment can also use the cap rotation module to extract and reflux the chemical liquid in the intermediate bulk container without departing from the spirit and scope of the present invention.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a schematic perspective diagram showing an integrated cap rotation equipment according to one embodiment of the present invention.

FIG. 2 illustrates a schematic perspective diagram showing an integrated cap rotation equipment according to another embodiment of the present invention.

FIG. 3 illustrates a schematic perspective diagram showing a cap rotation module of the integrated cap rotation equipment according to the embodiment of the present invention.

FIG. 4 illustrates a schematic perspective diagram showing an integrated connecting device of the integrated cap rotation equipment according to the embodiment of the present invention.

FIG. 5 illustrates a schematic perspective diagram showing an integrated cap rotation equipment according to further another embodiment of the present invention.

### DETAILED DESCRIPTION OF THE PREFERRED EMBODIMENT

The following description is of the best presently contemplated mode of carrying out the present disclosure. This description is not to be taken in a limiting sense but is made merely for the purpose of describing the general principles of the invention. The scope of the invention should be determined by referencing the appended claims.

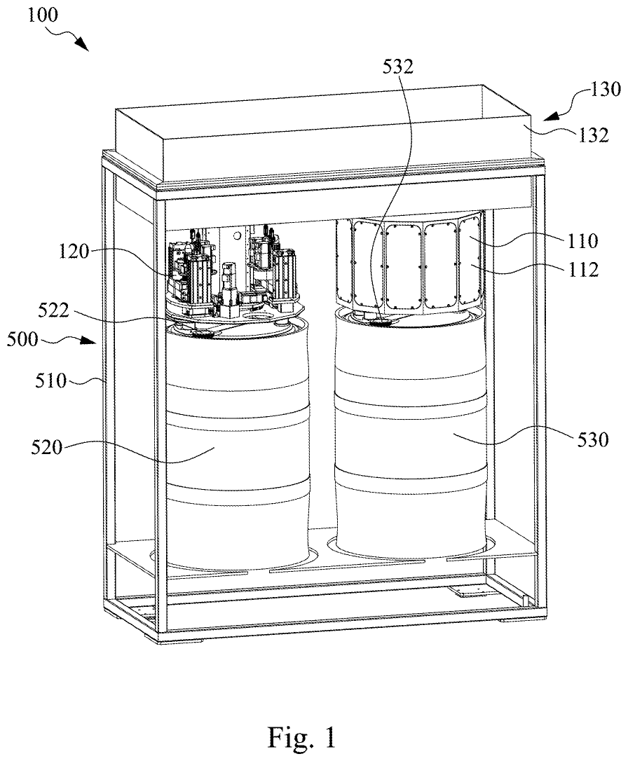

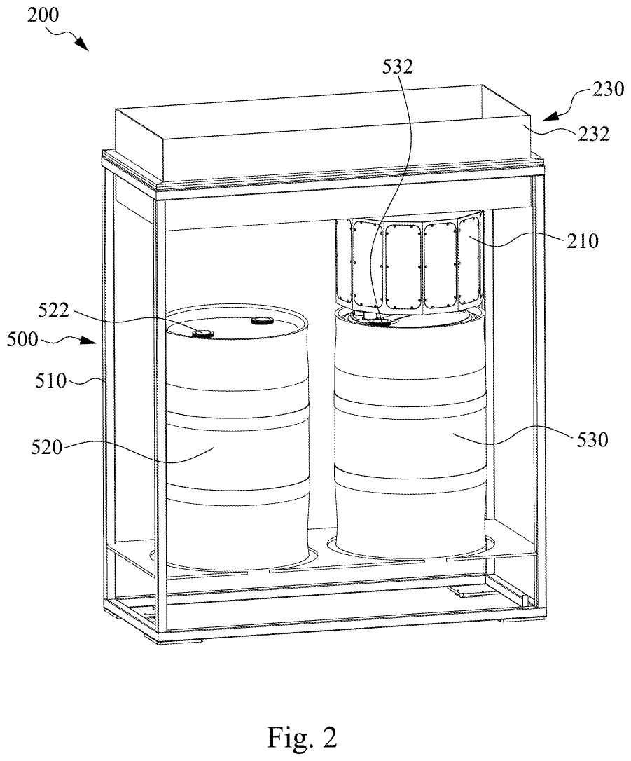

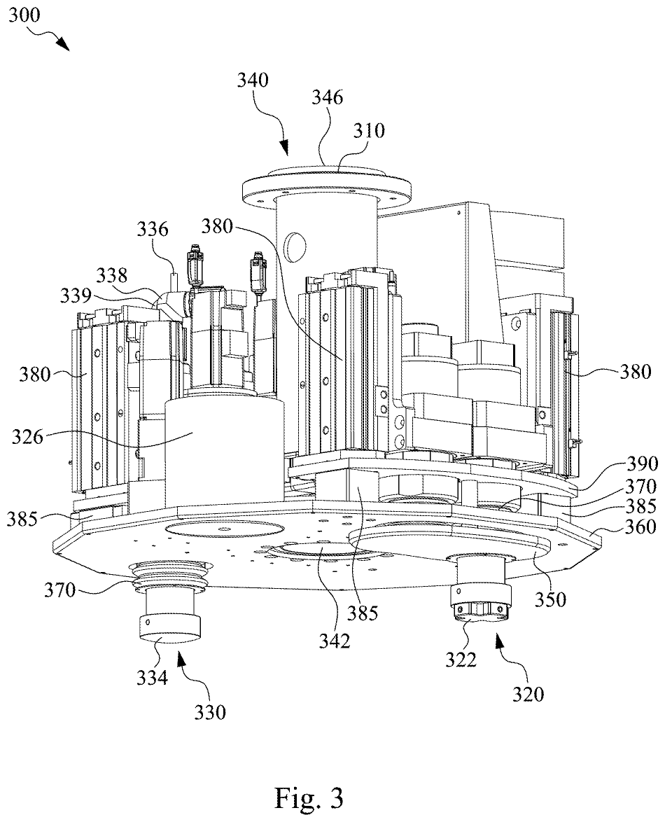

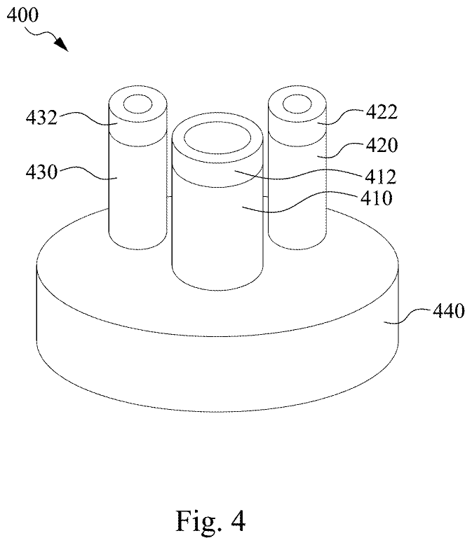

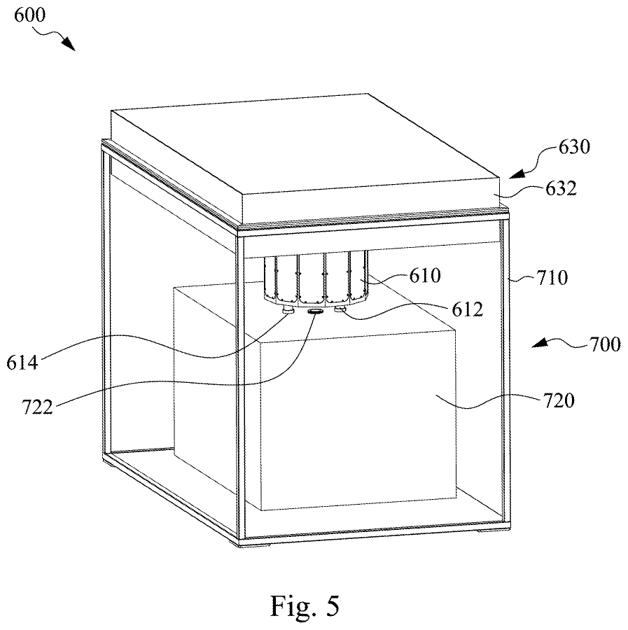

FIG. 1 illustrates a schematic perspective diagram showing an integrated cap rotation equipment according to one embodiment of the present invention, FIG. 2 illustrates a schematic perspective diagram showing an integrated cap rotation equipment according to another embodiment of the present invention, and FIG. 5 illustrates a schematic perspective diagram showing an integrated cap rotation equipment according to further another embodiment of the present invention. In addition, FIG. 3 illustrates a schematic perspective diagram showing a cap rotation module thereof and FIG. 4 illustrates a schematic perspective diagram showing an integrated connecting device thereof.

With reference to FIG. 1, the integrated cap rotation equipment 100 includes a cap rotation module supporter 130, a cap rotation module 110 and another cap rotation module 120. The cap rotation module 110 and the another cap rotation module 120 are equipped under the cap rotation module supporter 130, and the cap rotation module supporter 130 is equipped on the chemical storage container storing device 500. The chemical storage container storing device 500 includes a supporting frame 510 to store at least one chemical drum, e.g. a chemical drum 520 and a chemical drum 530, and the cap rotation module supporter 130 can be additional fixed on the supporting frame 510.

Further referring to FIG. 3, the cap rotation module 300 can be the cap rotation module 110 and/or the cap rotation module 120 of FIG. 1. The cap rotation module 300 includes a cap rotation device 320, an integrated connecting device 330, and an optical detecting device 326. The cap rotation device 320 can open the sealing cap 532 of the chemical drum 530, and the integrated connecting device 330 can connect the opening of the chemical drum 530 where the sealing cap 532 is opened to extract the chemical liquid from the chemical drum 530 and return the chemical liquid back to the chemical drum 530 so as to provide the chemical liquid of the manufacturing process in the factory. In addition, the integrated connecting device 330 can further provide an air, e.g. a nitrogen air or a clean dry air (CDA) for the chemical drum 530 to balance the pressure inside and outside the chemical drum 530.

In some embodiments, the cap rotation device 320 includes a cap rotator 322. The optical detecting device 326 is configured to detect a position of the sealing cap 532 of the chemical drum 530 to allow the cap rotator 322 exactly aligning with the sealing cap 532 and then opening the sealing cap 532.

In some embodiments, the integrated connecting device 330 includes a liquid extracting pipe 338, a liquid return pipe 339 and an air input pipe 336. The liquid extracting pipe 338 extracts the chemical liquid and transmit to the machine in the factory, and the liquid return pipe 339 can allow the redundant chemical liquid to be returned to the chemical drum 530. In addition, the air input pipe 336 can provide a nitrogen air and/or a clean dry air (CDA) to balance the pressure inside and outside the chemical drum 530.

The optical detecting device 326 is disposed between the cap rotation device 320 and the integrated connecting device 330 to detect the position of the sealing cap 532 of the chemical drum 530 so that the cap rotator 322 is able to exactly align with the sealing cap 532 and open the sealing cap 532, and then the integrated connecting device 330 moves to the opening where the sealing cap 532 is opened to seal the opening and extract the chemical liquid with the liquid extracting pipe 338, and the chemical liquid is transmitted to the machine in the factory. At the same time, the liquid return pipe 339 can transmit the redundant chemical liquid back to the chemical drum 530. In addition, the air input pipe 336 can provide the nitrogen air or the clean dry air (CDA) to balance the pressure inside and outside the chemical drum 530.

Furthermore, the cap rotation module 300 can further include a base plate 360 and a cap rotation module central post 310 connected to the base plate 360. The cap rotation device 320 and the integrated connecting device 330 are movably installed on the base plate 360.

In some embodiments, the cap rotation module 300 further includes a fixing plate 390, a vertical moving device 380 and a horizontal moving device 385. The vertical moving device 380, e.g. an air cylinder or a hydraulic cylinder, connects between the fixing plate 390 and the cap rotation device 320 or the integrated connecting device 330 to vertically move the cap rotation device 320 or the integrated connecting device 330, and the horizontal moving device 385 is disposed between the fixing plate 390 and the base plate 360 to horizontally move the cap rotation device 320 or the integrated connecting device 330.

With reference to FIG. 4, the integrated connecting device 400 of the integrated cap rotation equipment includes an integrated connecting head 440 to connect to the opening of the chemical storage container. In addition, the integrated connecting device 400 further includes a liquid extracting pipe 410, a liquid return pipe 420 and an air input pipe 430, respectively connecting to the integrated connecting head 440 to simultaneously connect to the opening of the chemical storage container. In some embodiments, the liquid extracting pipe 410, the liquid return pipe 420 and the air input pipe 430 respectively includes a check valve 412, a check valve 422 and a check valve 432 to avoid the reverse flows of the chemical liquid and air so as to guarantee the quality of the chemical liquid in the manufacturing process.

In some embodiments, the cap rotation device 320 and the integrated connecting device 330 respectively include a vertical moving device 380 to respectively move the cap rotation device 320 and the integrated connecting device 330 up and down. In some embodiments, the cap rotation device 320 and the integrated connecting device 330 can also utilize one vertical moving device 380 to simultaneously move the cap rotation device 320 and the integrated connecting device 330 up and down.

In some embodiments, the integrated cap rotation equipment 100 further includes an isolating plate 350 and an elastic isolating shield 370. The isolating plate 350 includes openings to respectively allow the cap rotator 322 and the integrated connecting head 334 penetrating therethrough. The elastic isolating shield 370 connects the isolating plate 350 and the base plate 360 to prevent the volatilized chemical gas of the chemical drum 530 from directly contacting, polluting and corroding the interior components of the cap rotation module 300. The isolating plate 350 of the integrated connecting device 330 has the same shape with the isolating plate 350 of the cap rotation device 320. In order to illustrate the interior components, the isolating plate 350 of the integrated connecting device 330 is omitted in FIG. 3.

In some embodiments, simultaneously referring to FIG. 1, the integrated cap rotation equipment 100 utilizes the base plate 360, the isolating plate 350 and the elastic isolating shield 370 to effectively isolate the volatilized chemical gas from the internal components of the cap rotation module 110 and the cap rotation module 120 of the integrated cap rotation equipment 100 to increase the safety and stability of the integrated cap rotation equipment 100. In addition, the cap rotation module 110 is further equipped with a sealing wall 112 connected to the base plate 360 to prevent the volatilized chemical gas from contacting the internal components of the cap rotation module 110 and the cap rotation module 120 of the integrated cap rotation equipment 100 thereby increasing the safety and stability of the integrated cap rotation equipment 100. In FIG. 1, the cap rotation module 120 does not illustrate the sealing wall to expose the interior components, which is convenient for explaining and understanding the interior components of the cap rotation module 110 and the cap rotation module 120.

In some embodiments, the cap rotation module central post 310 includes a ventilating channel 340, and the ventilating channel 340 includes a suction port 342 located in the base plate 360 and an exhaust port 346 connected to an external ventilating device to suck the volatilized chemical gases of the chemical drum 520 and the chemical drum 530 out of the cap rotation module 300 to prevent from pollution and corrosion so as to increase the lifespan of the integrated cap rotation equipment 100.

In some embodiments, the cap rotation module central post 310 can rotate to position the cap rotation device 320 and the integrated connecting device 330 to open the cap, and extract and return the chemical liquid.

Referring to FIG. 2, the integrated cap rotation equipment 200 utilizes a single cap rotation module 210 and a horizontal moving module 232 of the cap rotation module supporter 230 to move the cap rotation module 210 between the chemical drums, e.g. the chemical drum 520 and the chemical drum 530, and align with one of them to extract and return the required chemical liquid. Compared with the integrated cap rotation equipment 100 in FIG. 1, the integrated cap rotation equipment 100 uses a plurality of cap rotation modules to respectively connect to a plurality of chemical drums to extract and return the required chemical liquid. However, the integrated cap rotation equipment 200 adopts a single cap rotation module, which is able to connect to any one of a plurality chemical drums in the chemical storage container storing device 500 to extract and reflux the required chemical liquid.

Referring to FIG. 5, the integrated cap rotation equipment 600 utilizes a cap rotation module 610 and a horizontal moving module 632 in the cap rotation module supporter 630 to align the cap rotation module 610 with a sealing cap 722 of a chemical storage container 720, further utilizes the cap rotation device 612 to open the sealing cap 722, and then utilizes the integrated connecting device 614 to connect the opening on the chemical storage container 720 to extract and reflux the required chemical liquid and provide air to balance the internal and external pressure of the chemical storage container 720.

In some embodiments, the cap rotation module supporter 630 is installed on the supporting frame 710 of the chemical storage container storing device 700. In some embodiments, the cap rotation module supporter 630 can be also installed on the construction of the building, e.g. the ceiling of the building, above the chemical storage container storing device 700 and the chemical storage container 720 is disposed on the floor of the building to conveniently replace the chemical storage container 720 and extract the chemical liquid in the chemical storage container 720. In some embodiments, for example, the chemical storage container 720 can be an intermediate bulk container (IBC) which has the advantages of large capacity, light weight, high strength, acid and alkali resistance, corrosion resistance, space saving, and storage safety. The intermediate bulk container is used for the transportation and storage of chemical liquids in order to facilitate the transportation and storage of large amounts of chemical liquids used in factories.

Accordingly, the integrated cap rotation equipment can be safely and reliably configured above the existing chemical storage container, and utilizes a cap rotation device and an integrated connecting device to extract the chemical liquid in the chemical storage container. A single integrated connecting device can extract and reflux the chemical liquid and provide the required gas at the same time. In addition, the integrated cap rotation equipment can also be installed in the exclusive chemical storage container storing device, so as to use the chemical liquid in the chemical drum without departing from the spirit and the scope of the invention. Furthermore, the integrated cap rotation equipment can also utilize a single cap rotation module to extract and reflux the chemical liquid from multiple chemical drums, or multiple cap rotation modules to extract and reflux the chemical liquid from multiple chemical drums at the same time, which does not depart from the spirit and scope of the present invention. In addition, the integrated cap rotation equipment can also use the cap rotation module to extract and reflux the chemical liquid in the intermediate bulk container without departing from the spirit and scope of the present invention.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. An integrated cap rotation equipment, comprising:
a cap rotation module supporter; and
at least one cap rotation module coupling to the cap rotation module supporter, wherein the cap rotation module comprises:
a cap rotation device opening a sealing cap of a chemical storage container;
an integrated connecting device coupling to the opening of the chemical storage container to extract a chemical liquid from the chemical storage container and allow the chemical liquid returning to the chemical storage container; and
an optical detecting device disposing between the cap rotation device and the integrated connecting device, wherein the optical detecting device detects a position of the sealing cap of the chemical storage container to allow the cap rotation device aligning with the sealing cap and then the integrated connecting device aligning with the opening to utilize the cap rotation device opening the sealing cap and then the integrated connecting device extracting the chemical liquid.

2. The integrated cap rotation equipment of claim 1, wherein the integrated connecting device comprises an integrated connecting head, a liquid extracting pipe connecting to the integrated connecting head, a liquid return pipe connecting to the integrated connecting head and an air input pipe connecting to the integrated connecting head.

3. The integrated cap rotation equipment of claim 2, wherein the liquid extracting pipe, the liquid return pipe and the air input pipe respectively comprise a check valve.

4. The integrated cap rotation equipment of claim 3, wherein the cap rotation module supporter comprises a horizontal moving module to move the cap rotation module between a plurality of chemical storage containers and align with one of the chemical storage containers.

5. The integrated cap rotation equipment of claim 4, wherein a number of the at least one cap rotation module is plural, and each cap rotation module corresponds to one corresponding chemical storage container to extract the chemical liquid therein.

6. The integrated cap rotation equipment of claim 3, wherein the cap rotation module supporter comprises a horizontal moving module to move the cap rotation module aligning with the chemical storage container, and the chemical storage container is an intermediate bulk container (IBC).

7. The integrated cap rotation equipment of claim 6, further comprising a chemical storage container storing device, and the chemical storage container storing device comprises a supporting frame to store the intermediate bulk container and the cap rotation module supporter is disposed on the supporting frame.

8. The integrated cap rotation equipment of claim 7, wherein the cap rotation device comprises a cap rotator, the optical detecting device detects the position of the sealing cap of the chemical storage container to allow the cap rotator aligning with the sealing cap and opening the sealing cap.

9. The integrated cap rotation equipment of claim 8, further comprising:
a fixing plate;
a vertical moving device connecting between the fixing plate and the cap rotation device or between the fixing plate and the integrated connecting device to move the cap rotation device or the integrated connecting device; and
a horizontal moving device connecting between the fixing plate and a base plate to horizontal moving the cap rotation device or the integrated connecting device.

10. The integrated cap rotation equipment of claim 9, further comprising:
an isolating plate; and
an elastic isolating shield connecting to the isolating plate and the base plate to isolate a volatilized chemical gas of the chemical storage container.
